(19) United States
(12) Patent Application Publication
(10) Pub. No.: US 2008/0003090 A1
(43) Pub. Date: Jan. 3, 2008

(54) Loader support

(75) Inventor: Myung-Kwan Kim, Jinju-city (KR)

Correspondence Address: DILWORTH & BARRESE, LLP, 333 EARLE OVINGTON BLVD., SUITE 702, UNIONDALE, NY, 11553, US

(73) Assignee: Shin Dong Industrial Co., Ltd., Jinju-city (KR)

(21) Appl. No.: 11/477,688

(22) Filed: Jun. 29, 2006

(51) Int. Cl. B66C 23/00

(52) U.S. Cl. 414/686

(57) ABSTRACT

Disclosed herein is a loader support comprising a chassis coupling plate which is bolted to a front axle frame and a chassis of a tractor, a horizontal member which is welded to the chassis coupling plate to protrude outward, and a vertical member a which is welded to an outer end of the horizontal member to receive a boom support positioned on a rear end of a loader, wherein a reinforcement plate is welded to the chassis coupling plate, the vertical member a and the horizontal member in a state where the reinforcement plate is arranged at an inclined angle between the chassis coupling plate and the vertical member.

### BACKGROUND OF THE INVENTION

1. Field of the Invention

The present invention relates to a loader support; and more particularly, to a loader support which is simple and strong as a whole and has a reasonable structure for coupling with a loader.

2. Description of the Related Art

In general, a loader is one of major working machines mounted to the front of a tractor and is primarily used to transfer a heavy article such as a haystack within a short distance. However, since the loader performs the works for lifting a remarkably heavy haystack with a weight of about 1,000 kg by using a hydraulic pressure supplied from the tractor, respective portions of the loader should be strong and robust.

In order to secure the robustness of the loader, a loader support coupled to the left and right sides of a chassis of the tractor have a relatively complicated structure including a plurality of reinforcement members.

Further, the works for lifting and lowering the haystack and the like are generally composed of impulsive actions. In order to prevent the tractor serving as a power supply source and a main unit from being damaged due to the impact, the loader support should be strongly coupled with the tractor chassis via auxiliary members such as T-brackets or connection frames.

The aforementioned structural characteristics and conditions cause the loader support to be more complex, and thus, require too excessive works such as press and welding processes. Consequently, the manufacturing costs are inevitably increased.

Even though the conventional loader support has such a complicated structure as described above, it may not be able to sufficiently cope with the lateral shaking of a loader produced when the tractor turns around with a heavy article loaded thereon. Therefore, the tractor may be in trouble as a whole.

Further, when the tractor with the loader support coupled thereto is moved toward the loader to couple the tractor and the loader with each other, there is a problem in that considerable efforts are necessary to mutual coupling works, i.e. loader mounting works due to an unreasonable structure of a mutual coupling portion between the tractor and the loader.

### SUMMARY OF THE INVENTION

The present invention is conceived to solve the aforementioned problem in the prior art. Accordingly, a first object of the present invention is to provide a loader support having a robust support structure capable of clearly coping with the lateral shaking of a loader as well as having a simplified structure and its corresponding cost reduction effects.

A second object of the present invention is to provide a loader support by which a loader can be easily mounted due to a reasonable structure of a mutual coupling portion between the loader support and the loader.

The first object of the present invention can be achieved by causing a single reinforcement plate to be arranged at an inclined angle and welded between a chassis coupling plate which is directly coupled to a side surface of a tractor chassis including an engine and a transmission case and a vertical member which is vertically arranged at the side of the chassis coupling plate to receive a boom support positioned on a rear end of the loader.

The second object of the present invention can be achieved by providing a circular rod onto the boom support and a bent bracket for receiving the circular rod onto the vertical member in order to couple the boom support and the vertical member with each other.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a view showing both a loader and a tractor mounted with a loader support according to an embodiment of the present invention;

FIG. 2 is a front view of the tractor mounted with the loader support according to an embodiment of the present invention;

FIG. 3 is a front view of the loader support according to an embodiment of the present invention;

FIG. 4 is a partially cut-away right side view of the loader support according to an embodiment of the present invention;

FIG. 5 a plan view of the loader support according to an embodiment of the present invention; and

FIG. 6 is a view illustrating a mutual coupling relationship between the loader support and the loader according to an embodiment of the present invention.

### DETAILED DESCRIPTION OF THE PREFERRED EMBODIMENTS

Hereinafter, a preferred embodiment of the present invention will be described in detail with reference to the accompanying drawings.

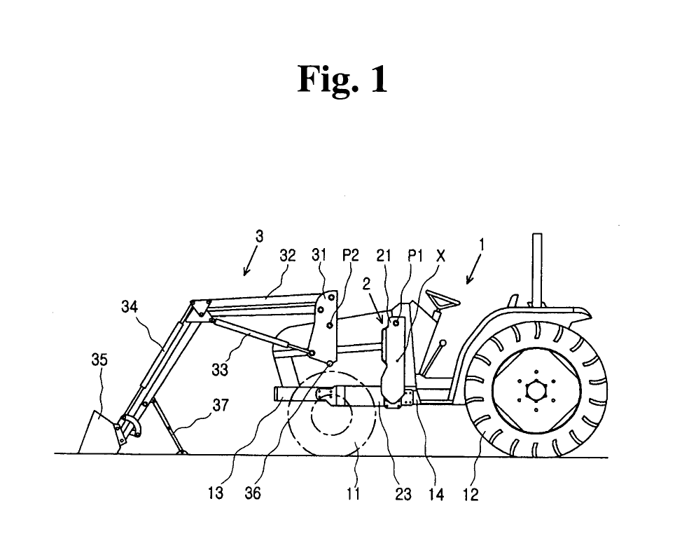

FIG. 1 shows a state where a loader support 2 of the embodiment of the present invention is mounted on a tractor 1.

A front end of a chassis coupling plate 23 is bolted to a side surface of a front axle frame 13 for supporting a lower end of an engine, whereas a rear end of the chassis coupling plate 23 is bolted to a side surface of a transmission case that constitutes a chassis 14 of a tractor.

A process of coupling the above loader support 2 and a loader 3 positioned in front of the loader support 2 with each other will be described later.

First, the tractor 1 is moved toward the loader 3 such that they are hydraulically connected with each other (i.e., their hydraulic hoses are connected with each other). Then, a control lever (not shown) mounted to the tractor 1 is manipulated to actuate an elevating hydraulic cylinder 33 and a tilting hydraulic cylinder 34 such that a circular rod 36 positioned at a lower end of a boom support 31 can be placed onto a bent bracket (positioned at a point X) in a vertical member 21.

That is, in a state where the circular rod 36 is placed on the bent bracket in the vertical member 21 of the loader support 2, the elevating hydraulic cylinder 33 and/or the tilting hydraulic cylinder 34 are actuated such that first and second pin holes P1 and P2 can be coincident with each other. Then, a pin is inserted into the pin holes P1 and P2 such that the loader support 2 and the loader 3 can be completely coupled with each other. The conventional boom support 31 is configured in such a manner that a bent bracket with an arcuate section is welded thereto instead of the circular rod 36.

Reference numerals 32, 35 and 37 not yet described designate a boom constituting a framework of the loader support 2, a bucket as an example of a tool which can be replaced according to the type of working objects, and a prop for supporting the loader 3 in a state where the loader has been separated from the loader support, respectively. Further, reference numerals 11 and 12 not yet described designate front and rear road wheels of the tractor, respectively.

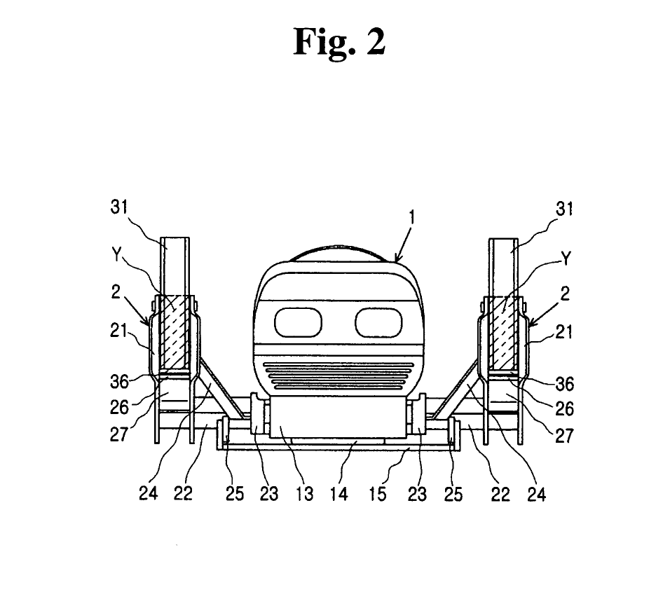

FIG. 2 is a front view of the tractor mounted with the loader support 2 according to the embodiment of the present invention.

As shown in the figure, the loader support 2 of the embodiment of the present invention comprises the chassis coupling plate 23 bolted to both the front axle frame 13 and the chassis 14 of the tractor; a horizontal member 22 welded to the chassis coupling plate 23 to protrude outward; and the vertical member 21 welded to an outer end of the horizontal member 22 to receive the aforementioned boom support directly therein. In particular, the loader support 2 is characterized in that a reinforcement plate 24 is welded to the chassis coupling plate 23 and the vertical member 21 as well as the horizontal member 22 in a state where it is arranged at an inclined angle between the chassis coupling plate 23 and the vertical member 21.

As described above, the reinforcement plate 24 welded to and between the chassis coupling plate 23 and the vertical member 21 plays an important role in sufficiently coping with the lateral shaking of the loader.

More specifically, the lateral shaking force and/or load transmitted to the vertical member is well distributed over the horizontal member 22 and the chassis coupling plate 23 via the reinforcement plate 24. Thus, the shaking force or load does not violently shake the tractor as a whole.

Further, the vertical member 21 is an elongated curved plate with an n-shaped section which has both sidewalls facing each other. Here, a bent bracket 26 is welded at the middle point in a longitudinal direction of the vertical member 21 to be laid across the opposite sidewalls such that a boom support receiving portion Y can be formed.

The bent bracket 26 is a plate member in which a concave portion capable of receiving the circular rod 36 of the lower end of the boom support 31 therein, i.e. capable of wrapping and supporting the circular rod 36, is formed by causing the plate to be horizontally bent at a middle portion of the plate.

The bent bracket may be angled as shown in the figures and may also be circularly curved into an arcuate shape corresponding to that of the circular rod 36.

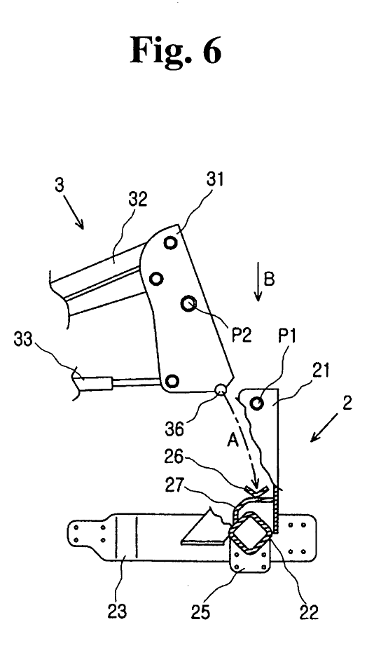

It is preferred that an additional reinforcement plate 27 (see FIG. 6) is welded between the bent bracket 26 and the horizontal member 22 serving as a pipe member welded to penetrate through the opposite sidewalls of the vertical member 21 at the lower ends thereof in order to allow the loader support to sufficiently hold load applied to the circular rod 36 of the boom support 31 while mounting the loader to the tractor.

As shown in the embodiment of the present invention, two attachment members 25 are welded at two positions on a lower end of the horizontal member 22 such that both ends of the T-bracket 15, which serves as an auxiliary connecting member for further firmly, i.e., integrally coupling the tractor chassis 14 and the loader support 2 with each other, are bolted to the attachment members 25, respectively.

The T-bracket 15 is a flat plate member bolted to a bottom surface of the transmission case. Here, the T-bracket 15 is configured in such a manner that a front upward protrusion thereof is coupled with the attachment member 25 of the loader support 2 such that large load applied to the loader support 2 can be supported by the whole tractor chassis 14.

In the meantime, the auxiliary connection member for allowing the tractor chassis 14 and the loader support 2 to be more firmly coupled with each other is not limited to the T-bracket 15. That is, the conventional connection frame (not shown) coupled to a rear axle frame at the rear road wheel 12 shown in FIG. 1 may be used as an auxiliary connection member.

Further, the welding points of the attachment members 25 are not limited to those on the lower end of the horizontal member 22 as shown in the figures. In other words, the loader support of the present invention is characterized by a supporting structure including the reinforcement plate 24 as described above. Thus, the welding points of the attachment members 25 need not be specifically limited as described above.

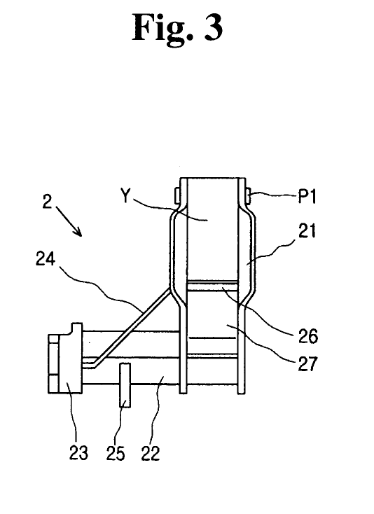

FIGS. 3 to 5 are front, partially cut-away right side and plan views illustrating the loader support according to the embodiment of the present invention, respectively.

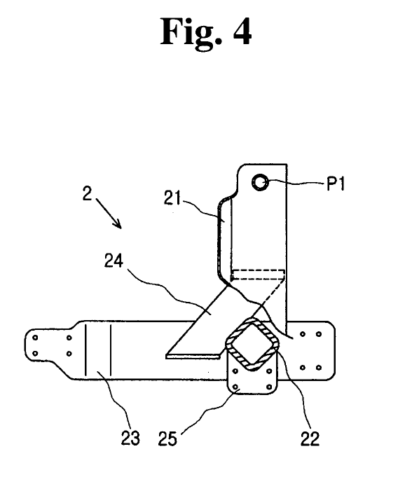

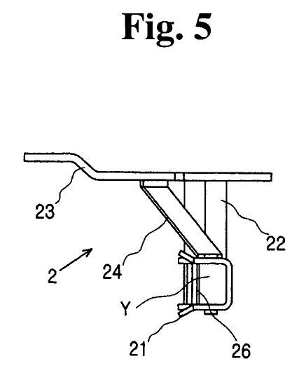

As described above, the reinforcement plate 24 arranged at an inclined angle between the chassis coupling plate 23 and the vertical member 21 is welded to not only the above members 23 and 21 but also the horizontal member 22. More preferably, a relevant portion of the reinforcement plate 24 which will be welded to the horizontal member 22 is partially cut away such that they can be more firmly welded to each other (see FIGS. 4 and 5).

An entrance of the boom support receiving portion Y of the vertical member 21 is slightly widened such that the boom support 31 can be smoothly introduced into the boom support receiving portion while mounting the loader to the tractor.

In the meantime, the attachment members 25 may be others than those on the lower end of the horizontal member 22. For example, the lower end of the vertical member 21 may extend downwardly and bolt holes for coupling the auxiliary connection member is formed on the very extending portion of the vertical member 21.

Further, as shown in FIG. 4, the chassis coupling plate 23 is formed with a plurality of bolt holes at both front and rear ends thereof. The front bolt holes are used to couple the chassis coupling plate with the front axle bracket as described above, whereas the rear bolt holes are used to couple the chassis coupling plate with the side surface of the transmission case.

From a strength standpoint, it is preferred that the horizontal member 22 be formed into a rectangular pipe member with a diamond shaped section, i.e. such a shape that two diagonal lines thereof are arranged horizontally and vertically, respectively.

However, the pipe member constituting the horizontal member 22 is not always limited to having a rectangular section. That is, the pipe member may have a circular section under certain circumstances.

FIG. 6 illustrates a mutual coupling relationship between the circular rod on the lower end of the boom support and the bent bracket in the vertical member of the loader support. Referring to FIG. 6, a preferable loader mounting mechanism of the loader support according to the embodiment of the present invention will be now described.

For better understanding of the present invention, the loader mounting mechanism will be explained with reference to a state where some portions of the outer sidewall among both sidewalls of the vertical member 21 are cut away.

The circular rod 36 on the lower end of the boom support 31 is placed into the concave region on the bent bracket 26 in the vertical member 21 along a moving path indicated by an arrow A in the process of operating the hydraulic cylinders 33 and 34 of the loader 3 to insert a portion of the boom support 31 into the vertical member 21, i.e. a loader mounting operation, in a state where the tractor and the loader support 2 are stationary.

By the way, when a worker who performs the loader mounting operation in a state where he/she generally stands up in front of the driver's seat of the tractor or gets off the tractor near the front side of the tractor, his/her line of vision may be illustrated as an arrow B.

Accordingly, even until the circular rod 36 is placed onto the bent bracket 26, the worker can clearly recognize a situation where the above two members, i.e. the circular rod 36 and the bent bracket 26, are approached and engaged with each other.

As the boom support 31 gradually takes a vertical posture, the circular rod 36 will disappear under the boom support 31, i.e. the worker may guess the position of the circular rod 36. However, the bent bracket 26 with a larger area than the circular rod 36 is still in a state where a rear end of the bracket can be viewed by the worker under the lower end of the boom support 31.

Since the object (i.e., the bent bracket 26) to be coupled with the circular rod 36 on the lower end of the boom support 31 can be clearly distinguished by the worker, the circular rod 36 can be easily placed onto the bent bracket 26 without greatly deviating from a coupling position where the circular rod 36 and the bent bracket 26 are coupled with each other.

In other words, the loader mounting process can be very easily performed without trial and error.

From this point of view, it may be preferable that the circular rod 36 be positioned on the lower end of the boom support 31 to be adjacent to the rear end of the boom support.

Meanwhile, in the conventional loader support and the boom support, the positional relationship between the circular rod 36 and the bent bracket 26 is reverse to that of the embodiment shown in FIG. 6. Therefore, if the boom support 31 is slightly introduced into the vertical member 21, a target coupling position, i.e. the circular rod, is completely hidden by the lower end of the boom support 31. Consequently, a worker should have performed the correct mutual coupling (i.e., engagement) between the circular rod 36 and the bent bracket 26 by trial and error.

As described above, the structure of the loader support of the present invention can be simplified, and thus, the production costs can also be reduced. In addition, the loader support can have the robust supporting structure capable of clearly coping with the lateral shaking of the loader.

The simplified structure of the loader support results in the improvement in an external appearance of the product, i.e. a compact and smart design of the product.

Further, since the coupling structure with the loader is reasonable, the efforts of the worker can be greatly reduced during the loader mounting operation, which becomes an incidental but important effect.

Although the loader support according to the embodiment of the present invention has been described in detail with reference to the accompanying figures, it can be understood by those skilled in the art that various modifications and changes can be made thereto without departing from the scope and spirit of the present invention.

However, it should be understood that minor design changes made within the scope of the appended claims would be included in the technical scope of the present invention.

1. A loader support, comprising:
a chassis coupling plate bolted to a front axle frame and a chassis of a tractor;
a horizontal member welded to the chassis coupling plate to protrude outward; and
a vertical member welded to an outer end of the horizontal member to receive a boom support positioned on a rear end of a loader,
wherein a reinforcement plate is welded to the chassis coupling plate, the vertical member and the horizontal member in a state where the reinforcement plate is arranged at an inclined angle between the chassis coupling plate and the vertical member.

2. The loader support as claimed in claim 1, wherein a bent bracket is welded to the vertical member across both sidewalls of the vertical member defining a boom support receiving portion.

3. The loader support as claimed in claim 1, wherein the horizontal member is a rectangular pipe with a diamond shaped section.

4. The loader support as claimed in claim 1, wherein the horizontal member is a circular pipe.

5. The loader support as claimed in claim 3, wherein an attachment member for coupling with an auxiliary connection member coupled to the tractor chassis is welded to the horizontal member.

6. The loader support as claimed in claim 5, wherein a T-bracket fastened to a lower end of the tractor chassis is coupled with the attachment member.

7. The loader support as claimed in claim 5, wherein a connection frame fastened to a rear axle frame of the tractor is coupled with the attachment member.
